(19) United States
(12) Patent Application Publication
(10) Pub. No.: US 2026/0036857 A1
(43) Pub. Date: Feb. 5, 2026

(54) BEAM SPLITTER AND OPTICAL WAVELENGTH SELECTIVE SWITCH SYSTEM

(71) Applicant: FUJIFILM Corporation, Tokyo (JP)

(72) Inventors: Kazuya HISANAGA, Minamiashigara-shi (JP); Yujiro YANAI, Minamiashigara-shi (JP); Yukito SAITOH, Minamiashigara-shi (JP)

(73) Assignee: FUJIFILM Corporation, Tokyo (JP)

(21) Appl. No.: 19/355,062

(22) Filed: Oct. 10, 2025

Related U.S. Application Data
(63) Continuation of application No. PCT/JP2024/014759, filed on Apr. 12, 2024.

(30) Foreign Application Priority Data
Apr. 13, 2023 (JP) 2023-065728

(51) Int. Cl. G02F 1/139; G02F 1/1335

(52) U.S. Cl. CPC G02F 1/1396; G02F 1/133528

(57) ABSTRACT

An object is to provide a thin beam splitter and an optical wavelength selective switch system including the beam splitter. The beam splitter includes: a light splitting element that splits incidence light into transmitted light and transmitted diffracted light; and a light collimating member for collimating the split light components, in which a splitting angle between the transmitted light and the transmitted diffracted light is 100 or more. As a result, the object is achieved.

### CROSS-REFERENCE TO RELATED APPLICATIONS

This application is a Continuation of PCT International Application No. PCT/JP2024/014759 filed on Apr. 12, 2024, which claims priority under 35 U.S.C. § 119(a) to Japanese Patent Application No. 2023-065728 filed on Apr. 13, 2023. The above applications are hereby expressly incorporated by reference, in their entirety, into the present application.

### BACKGROUND OF THE INVENTION

### 1. Field of the Invention

The present invention relates to a field of an optical communication technique, and particularly relates to a beam splitter and an optical wavelength selective switch system.

### 2. Description of the Related Art

In order to deal with an increase in network capacity in an optical transmission network, it is desired to increase the performance of an optical wavelength selective switch (WSS) used in wavelength division multiplexing and to increase the number of usable switches through a reduction in size.

In the current optical wavelength selective switch system, a beam splitter is used for splitting and adjusting an input beam or an output beam. Typically, the following method is used. Regarding the input beam, the beam spread is adjusted by a micro lens array, a collimating lens, or the like, and the adjusted input beam is incident into the beam splitter. As the beam splitter, for example, a beam displacer or a Wollaston prism is used. After passing through this element, the input beam is split into two beams. Polarization states of these beams are linearly polarized light components whose polarization directions are perpendicular to each other. The polarization state of one beam is rotated by a retardation plate to obtain linearly polarized light components whose polarization directions are parallel to each other. In addition, by allowing the two beams to be incident into a desired location of the element, the same optical path can also be obtained. A material of this beam splitter consists of MgF₂, YVO₄, calcite, or the like.

However, regarding this beam splitter, the element thickness increases due to characteristics of the material. In addition, the position adjustment of the element is necessary for appropriately splitting and adjusting light in a desired direction, and a space for the position adjustment is further necessary in the vicinity of the element, which is a rate-controlling factor for a reduction in the size of the entire device. In addition, surface smoothness is very important. Therefore, a high-precision polishing technique is necessary, and a complicated process is also necessary for assembly of the element.

### SUMMARY OF THE INVENTION

An object of the present invention is to provide a thin beam splitter and an optical wavelength selective switch system including the beam splitter.

In order to achieve the object, the present invention has the following configurations.

[1] A beam splitter comprising:
a light splitting element that splits incidence light into transmitted light and transmitted diffracted light; and
a light collimating member for collimating the split light components,
in which a splitting angle between the transmitted light and the transmitted diffracted light is 100 or more.

[2] The beam splitter according to [1],
in which the light splitting element is a transmissive liquid crystal diffractive element having a twisted structure of liquid crystals.

[3] The beam splitter according to [1] or [2],
in which the light collimating member is a transmissive liquid crystal diffractive element having a twisted structure of liquid crystals.

[4] The beam splitter according to any one of [1] to [3], further comprising:
a retardation plate that is provided between the light splitting element and the light collimating member or on an emission side of the light collimating member.

[5] An optical wavelength selective switch system comprising:
the beam splitter according to any one of [1] to [4].

According to the present invention, the element itself can be made thin, and the size of the entire device can also be reduced. In addition, the present invention can also provide an optical system.

### BRIEF DESCRIPTION OF THE DRAWINGS

FIG. 1 is a conceptual diagram showing a configuration of the present invention.

FIG. 2 is a conceptual diagram showing the configuration of the present invention.

FIG. 3 is a conceptual diagram showing the configuration of the present invention.

FIG. 4 is a conceptual diagram showing the configuration of the present invention.

FIG. 5 is a conceptual diagram showing the configuration of the present invention.

FIG. 6 is a conceptual diagram showing the configuration of the present invention.

FIG. 7 is a conceptual diagram showing the configuration of the present invention.

### DESCRIPTION OF THE PREFERRED EMBODIMENTS

Hereinafter, the present invention will be specifically described.

The following configuration requirements will be described based on typical embodiments of the present invention in some cases, but the present invention is not limited to the embodiments.

In the present specification, numerical ranges represented by “to” refer to ranges including numerical values before and after “to” as lower limit values and upper limit values.

In the present specification, materials that correspond to each of components may be used alone or in combination of two or more kinds. Here, in a case where two or more kinds of materials are used in combination for each of components, the content of the component refers to the total content of the materials to be combined unless specified otherwise.

In the present specification, “(meth)acrylate” represents “either or both of acrylate and methacrylate”.

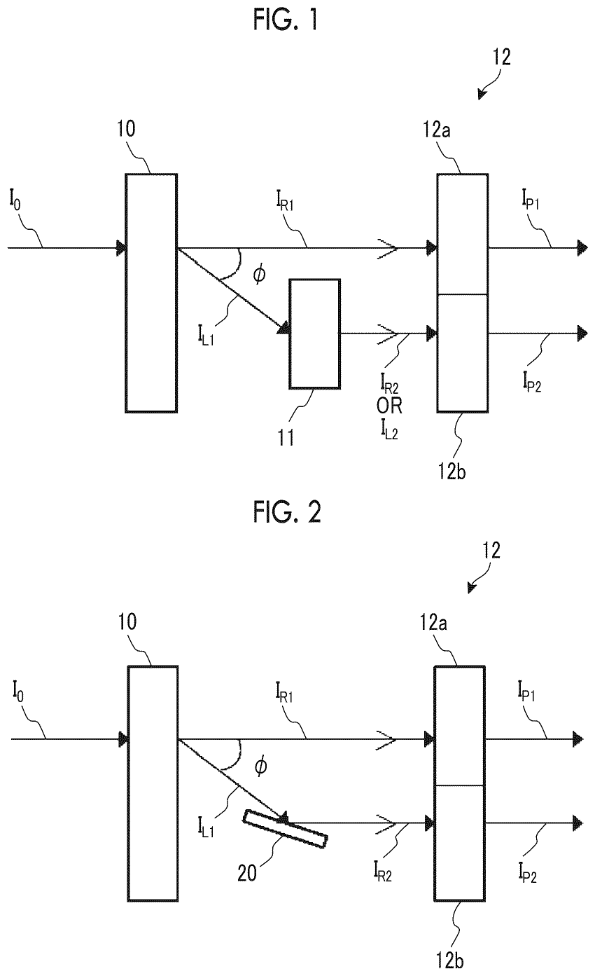

FIG. 1 is a diagram conceptually showing a configuration of a beam splitter according to the present invention.

The beam splitter shown in FIG. 1 includes a light splitting element 10, a light collimating member 11, and a retardation plate 12.

In the beam splitter according to an embodiment of the present invention, the light splitting element 10 is a diffractive element that diffracts one circularly polarized light component in incident light to allow transmission thereof and that allows transmission of the other circularly polarized light component in the incident light without diffracting the other circularly polarized light component. In addition, in the present invention, a splitting angle of light by the light splitting element 10, that is, an angle between light transmitted through the light splitting element 10 and the light that is transmitted and diffracted is 100 or more.

In the example shown in FIG. 1, the light splitting element 10 is a diffractive element that allows transmission of dextrorotatory circularly polarized light and diffracts levorotatory circularly polarized light to allow transmission thereof. Accordingly, in a case where unpolarized light I₀ is incident into the light splitting element 10, in incidence light I₀, only the levorotatory circularly polarized light component is diffracted and emitted as levorotatory circularly polarized light I_{L1}. In addition, the dextrorotatory circularly polarized light component of the incidence light I₀ is emitted as the dextrorotatory circularly polarized light I_{R1} without any change. The diffracted levorotatory circularly polarized light I_{L1} is emitted at an angle φ with respect to the normal line of the light splitting element 10. The angle φ includes an error of about ±0.1°.

In the example shown in FIG. 1, in the light splitting element 10, the incidence light I₀ that is vertically incident into the surface of the light splitting element 10 from the left direction in the drawing is split into two circularly polarized light components, the dextrorotatory circularly polarized light I_{R1} transmitted through the light splitting element 10 without being diffracted travels in the right direction in the drawing, and the levorotatory circularly polarized light I_{L1} diffracted and transmitted through the light splitting element 10 travels in the lower right direction in the drawing.

The levorotatory circularly polarized light I_{L1} is incident into the light collimating member 11.

In the beam splitter according to the embodiment of the present invention, the light collimating member 11 is a member that changes travel directions of the light components that are split by the light splitting element 10 to travel in the two different directions such that the light components travel in directions parallel to each other while being split.

In the example shown in FIG. 1, the light collimating member 11 is disposed on an optical path of the diffracted levorotatory circularly polarized light I_{L1}, and the levorotatory circularly polarized light I_{L1} incident from the upper left direction in the drawing is deflected to travel in the right direction in the drawing. As a result, the dextrorotatory circularly polarized light I_{R1} and the dextrorotatory circularly polarized light I_{R2} (or the levorotatory circularly polarized light I_{L2}) travel in directions parallel to each other.

The dextrorotatory circularly polarized light I_{R1} and the dextrorotatory circularly polarized light I_{R2} (or the levorotatory circularly polarized light I_{L2}) that are collimated are incident into the retardation plate 12.

As shown in FIG. 1, the light collimating member 11 may deflect the incident circularly polarized light while maintaining the polarization state of the circularly polarized light, or may convert and deflect the incident circularly polarized light into polarized light components orthogonal to each other.

That is, the light collimating member 11 may deflect the incident levorotatory circularly polarized light I_{L1} as the levorotatory circularly polarized light I_{L2} without any change, and may deflect and convert the incident levorotatory circularly polarized light I_{L1} into the dextrorotatory circularly polarized light I_{R2}.

In the example shown in FIG. 1, the light collimating member 11 is configured to deflect only the circularly polarized light diffracted by the light splitting element 10 to collimate the two light components. However, the present invention is not limited to this configuration, and the light collimating member 11 may be configured to deflect only the circularly polarized light not diffracted by the light splitting element 10 to collimate the two light components. That is, the light collimating member 11 may be disposed on an optical path of the circularly polarized light that is not diffracted by the light splitting element 10, and may deflect this circularly polarized light such that the travel direction of the circularly polarized light is parallel to the travel direction of the circularly polarized light diffracted by the light splitting element 10. Alternatively, the light collimating member 11 may be configured to deflect each of the two circularly polarized light components split by the light splitting element 10 to collimate the two light components.

In the example shown in FIG. 1, as a preferable aspect, the retardation plate 12 is provided. The retardation plate 12 is a member that changes the polarization state of light split by the light splitting element 10.

In the example shown in FIG. 1, the retardation plate 12 is disposed on an emission side of the light collimating member 11, converts the incident dextrorotatory circularly polarized light I_{R1} into linearly polarized light (P polarized light Iri), and converts the incident dextrorotatory circularly polarized light I_{R2} (or the levorotatory circularly polarized light I_{L2}) into linearly polarized light (P polarized light I_{P2}). That is, in the example shown in FIG. 1, the retardation plate 12 converts the two circularly polarized light components into linearly polarized light components having the same polarization direction. The linearly polarized light emitted from the retardation plate 12 being P polarized light represents linearly polarized light in a polarization state that is incident as P polarized light with respect to an optical member disposed on a rear stage of the retardation plate 12.

Accordingly, the retardation plate 12 is a λ/4 plate. In addition, in a case where the turning directions of the two circularly polarized light components are opposite to each other, slow axis directions of a region 12a where the dextrorotatory circularly polarized light I_{R1} is incident and a region 12b where the levorotatory circularly polarized light I_{L2} is incident are different by substantially 90°.

From the above, the beam splitter shown in FIG. 1 splits incident light into two linearly polarized light components to emit the two linearly polarized light components in directions parallel to each other.

In the beam splitter according to the embodiment of the present invention, a diffractive element that splits incidence light into transmitted light and transmitted diffracted light is used as the light splitting element. Therefore, even in a case where a splitting angle of light by the light splitting element is 100 or more, the light splitting element can be thinned. In addition, the splitting angle of light by the light splitting element is 100 or more, and thus even in a case where a distance between the light splitting element and the light collimating member is short, travel directions of the split light components can be collimated in a state where the split light components are sufficiently spaced. Therefore, the thickness (size) of the entire device can be reduced.

In the example shown in FIG. 1, the retardation plate 12 is disposed on the emission side of the light collimating member 11. However, the present invention is not limited to this example, and the retardation plate 12 may be disposed between the light splitting element 10 and the light collimating member 11. Regarding this point, the same also applies to each example described below.

In addition, in the example shown in FIG. 1, the retardation plate 12 converts the two circularly polarized light components that are incident into linearly polarized light components having the same orientation. However, the present invention is not limited to this example, and the two circularly polarized light components may be converted into linearly polarized light components orthogonal to each other. Regarding this point, the same also applies to each example described below.

In addition, in the example shown in FIG. 1, the configuration including the retardation plate 12 is adopted. However, a configuration not including the retardation plate may be adopted. In this case, the beam splitter can emit the split circularly polarized light components in directions parallel to each other. Regarding this point, the same also applies to each example described below.

### [Light Splitting Element]

The light splitting element 10 shown in FIG. 1 is a transmissive diffractive element represented by a liquid crystal diffractive element including a support, a photo-alignment film, and an optically anisotropic film, a surface relief element having a fine uneven pattern. In particular, the optically anisotropic film is formed of a composition including a liquid crystal compound and has a predetermined liquid crystal alignment pattern in which an orientation of an optical axis derived from the liquid crystal compound continuously rotates in one in-plane direction. In addition, the optically anisotropic film has a so-called twisted structure in which the orientation of the molecular axis of the liquid crystal compound continuously changes from one interface side to the other interface side in a thickness direction. By allowing a rotation direction of the twisted structure to be one direction (right-twisted or left-twisted), the transmitted light and the transmitted diffracted light can be split from each other. In addition, the surface relief element diffracts a S-polarized component and does not substantially diffract a P-polarized component with respect to light that is obliquely incident. Therefore, the transmitted light and the transmitted diffracted light can be split from each other.

In the transmissive liquid crystal diffractive element, the twist of the twisted structure in the thickness direction is less than one turn, that is, a twisted angle thereof is less than 360°. The twisted angle of the liquid crystal compound in the thickness direction is preferably about 10° to 200° and more preferably 20° to 180°. On the other hand, in the case of a cholesteric liquid crystal layer that reflects light, the twisted angle is 360° or more, and selective reflectivity in which specific circularly polarized light in a specific wavelength range is reflected is exhibited. In the present specification, “twisted alignment” does not include cholesteric alignment, and selective reflectivity does not occur in the liquid crystal diffractive element (optically anisotropic film) having the twisted alignment.

The liquid crystal diffractive element, the support, the photo-alignment film, and the optically anisotropic film can be found in WO2021/256413A. Note that, in a case where, for use in optical communication, the fact that the used wavelength is infrared needs to be considered. Since the optically anisotropic film functions as the liquid crystal diffractive element, the support and/or the photo-alignment film does not need to be provided.

### (Transmissive Liquid Crystal Diffractive Element)

As is well known, the transmissive liquid crystal diffractive element diffracts incident circularly polarized light according to the turning direction. In addition, in the transmissive liquid crystal diffractive element, in a case where the optically anisotropic film has the twisted structure where the orientation of the liquid crystal compound continuously changes in the thickness direction, the diffraction efficiency with respect to one circularly polarized light can be made high, and the diffraction efficiency with respect to the other circularly polarized light can be made low. As a result, in the liquid crystal diffractive element having the twisted structure, one circularly polarized light can transmit through the liquid crystal diffractive element to be diffracted, the other circularly polarized light can transmit through the liquid crystal diffractive element without being diffracted, and the transmitted light and the transmitted diffracted light can be split from each other.

In addition, a diffraction angle in the transmissive liquid crystal diffractive element is determined depending on a distance (in-plane pitch a) in which the orientation of the liquid crystal compound continuously changes from 0 to 1800 in a plane in the predetermined liquid crystal alignment pattern in which the orientation of the optical axis derived from the liquid crystal compound rotates in the one in-plane direction.

In the case of the transmissive liquid crystal diffractive element, a liquid crystal material and a film thickness may be appropriately selected such that Δnλ×d represented by the product of refractive index anisotropy Δnλ at a wavelength λ [nm] of the optically anisotropic film and a film thickness d [nm] of the liquid crystal layer is λ/2.

In addition, the in-plane pitch a [nm] is determined from the following expression of first-order diffracted light, and the photo-alignment film may also be appropriately subjected to interference exposure based on the in-plane pitch a.

$$n \times a \times ( sin β - sin α ) = λ$$

Here, the in-plane pitch a is a distance in which the orientation of the molecular axis of the liquid crystal compound continuously changes from 0 to 180° in a plane. In addition, n represents an environmental refractive index of the incidence side in contact with the liquid crystal diffractive element, a represents an angle between light incident into the liquid crystal diffractive element and the normal line of the liquid crystal diffractive element surface, and p represents an angle between transmitted diffracted light and the normal line of the liquid crystal diffractive element surface, and X represents a wavelength [nm] of incidence light.

(Formation of in-Plane Alignment Pattern)

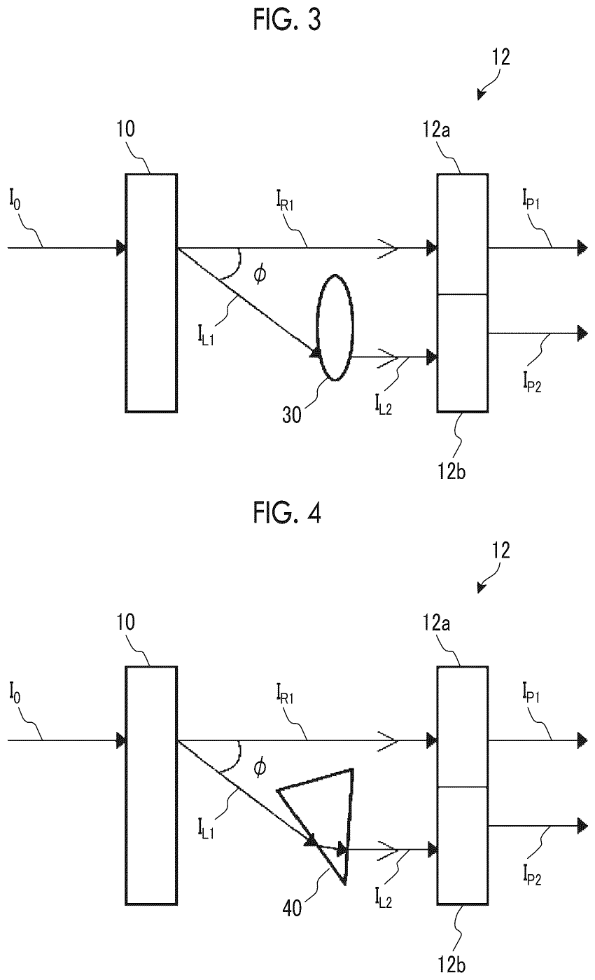

In addition, in order to form the in-plane alignment pattern required for diffraction, although not particularly limited thereto, interference exposure using circularly polarized light may be used as in an exposure device shown in FIG. 3 of WO2021/256413A. In order to obtain the in-plane pitch required for the splitting angle, an optical element of the exposure device may be provided such that absolute values of incidence angles of the interference exposure with respect to the normal direction of the photo-alignment film surface are the same.

### (Formation of Twisted Structure)

In order to obtain the twisted structure in the thickness direction, the addition amount of a chiral agent may be appropriately adjusted as described in WO2021/256413A.

### [Light Collimating Member]

In FIG. 1, the levorotatory circularly polarized light I_{L1} that is diffracted and emitted from the light splitting element 10 is incident into the light collimating member 11 to be parallel to the dextrorotatory circularly polarized light I_{R1} transmitted through the light splitting element 10.

In this case, the parallel light only needs to be parallel light that can be applied as a wavelength selective switch instead of strictly parallel light, and the error thereof is about ±0.1°.

The light collimating member for collimating the split light components may be a refractive element, a diffractive element, or a reflective element, but is not limited thereto. For example, the refractive element is a lens, a prism, or the like, and the reflective element is a mirror. In addition, the diffractive element is not particularly limited, and the liquid crystal diffractive element is preferable from the viewpoint that the size of the entire device can be reduced because the element itself is thin and is bondable.

### [Retardation Plate]

The retardation plate is not particularly limited but is preferable because a change in polarization such as reflection or refraction is not likely to occur in a state where the polarization state after the passage is linearly polarized light. In addition, the material is not particularly limited, and a well-known material such as a polymer, liquid crystal, or an inorganic matter can be used.

FIG. 2 is a diagram conceptually showing another example of the configuration of the beam splitter according to the embodiment of the present invention. The beam splitter shown in FIG. 2 includes the light splitting element 10, a mirror 20 as the light collimating member, and the retardation plate 12. The example shown in FIG. 2 has the same configuration as the example shown in FIG. 1, except that it includes the mirror 20 as the light collimating member, and thus different points will be mainly described in the following description.

In FIG. 2, the mirror 20 is disposed on the optical path of the levorotatory circularly polarized light I_{L1} split by the light splitting element 10, and reflects the incident levorotatory circularly polarized light I_{L1} to change the travel direction. In the example shown in FIG. 2, the mirror 20 reflects the levorotatory circularly polarized light I_{L1} traveling in the lower right direction in the drawing such that the levorotatory circularly polarized light I_{L1} travels in the right direction in the drawing. The circularly polarized light reflected from the mirror 20 is converted in polarization direction, and thus is emitted as the dextrorotatory circularly polarized light I_{R2}.

The levorotatory circularly polarized light I_{L1} reflected from the mirror 20 is incident into the region 12b of the retardation plate 12 to be converted into the linearly polarized light I_{P2}, and the dextrorotatory circularly polarized light I_{R1} that transmits through the light splitting element 10 without being diffracted is directly incident into the region 12a of the retardation plate 12 to be converted into the linearly polarized light I_{P1}.

From the above, the beam splitter shown in FIG. 2 splits incident light into two linearly polarized light components to emit the two linearly polarized light components in directions parallel to each other.

FIG. 3 is a diagram conceptually showing another example of the configuration of the beam splitter according to the embodiment of the present invention.

The beam splitter shown in FIG. 3 includes the light splitting element 10, a lens 30 as the light collimating member, and the retardation plate 12. The example shown in FIG. 3 has the same configuration as the example shown in FIG. 1, except that it includes the lens 30 as the light collimating member, and thus different points will be mainly described in the following description.

In FIG. 3, the lens 30 is a convex lens (condenser lens), and changes the travel direction of the levorotatory circularly polarized light I_{L1} split by the light splitting element 10 to a direction parallel to the dextrorotatory circularly polarized light I_{R1} due to the focusing action.

Specifically, as shown in FIG. 3, the levorotatory circularly polarized light I_{L1} split by the light splitting element 10 travels in the lower right direction in the drawing to be incident into the vicinity of an end part of the lens 30 on the lower side in the drawing. Due to the focusing action of the lens 30, the travel direction of the levorotatory circularly polarized light I_{L1} incident into the lens 30 is bent to the central axis side such that the levorotatory circularly polarized light I_{L1} is emitted in the right direction in the drawing. In this case, the levorotatory circularly polarized light I_{L1} incident into the lens 30 is emitted as the levorotatory circularly polarized light I_{L2} without any change.

The levorotatory circularly polarized light I_{L2} emitted from the lens 30 is incident into the region 12b of the retardation plate 12 to be converted into the linearly polarized light I_{P2}. In addition, the dextrorotatory circularly polarized light I_{R1} that transmits through the light splitting element 10 without being diffracted is directly incident into the region 12a of the retardation plate 12 to be converted into the linearly polarized light Iri.

From the above, the beam splitter shown in FIG. 3 splits incident light into two linearly polarized light components to emit the two linearly polarized light components in directions parallel to each other.

FIG. 4 is a diagram conceptually showing another example of the configuration of the beam splitter according to the embodiment of the present invention.

The beam splitter shown in FIG. 4 includes the light splitting element 10, a prism 40 as the light collimating member, and the retardation plate 12. The example shown in FIG. 4 has the same configuration as the example shown in FIG. 1, except that it includes the prism 40 as the light collimating member, and thus different points will be mainly described in the following description.

In FIG. 4, the prism 40 is a so-called triangular prism, is disposed on the optical path of the levorotatory circularly polarized light I_{L1} diffracted by the light splitting element 10, and bends and changes the travel direction of the levorotatory circularly polarized light I_{L1} to a direction parallel to the dextrorotatory circularly polarized light I_{R1} transmitted through the light splitting element 10.

Specifically, as shown in FIG. 4, a surface (hereinafter, referred to as an incident surface) of the prism 40 into which the levorotatory circularly polarized light I_{L1} is incident is disposed to be inclined with respect to the surface of the light splitting element 10, and is disposed such that the levorotatory circularly polarized light I_{L1} is incident from a direction oblique to the incident surface. That is, assuming that the angle of light with respect to the perpendicular of the incident surface is an incidence angle, the prism 40 is disposed such that the incidence angle of the levorotatory circularly polarized light I_{L1} is large.

The levorotatory circularly polarized light I_{L1} incident into the prism 40 at the large incidence angle largely changes in travel direction to be emitted in the right direction in the drawing. In addition, in this case, the levorotatory circularly polarized light I_{L1} incident into the prism 40 is emitted as the levorotatory circularly polarized light I_{L2} without any change.

The levorotatory circularly polarized light I_{L2} emitted from the prism 40 is incident into the region 12b of the retardation plate 12 to be converted into the linearly polarized light I_{P2}. In addition, the dextrorotatory circularly polarized light I_{R1} that transmits through the light splitting element 10 without being diffracted is directly incident into the region 12a of the retardation plate 12 to be converted into the linearly polarized light II.

From the above, the beam splitter shown in FIG. 4 splits incident light into two linearly polarized light components to emit the two linearly polarized light components in directions parallel to each other.

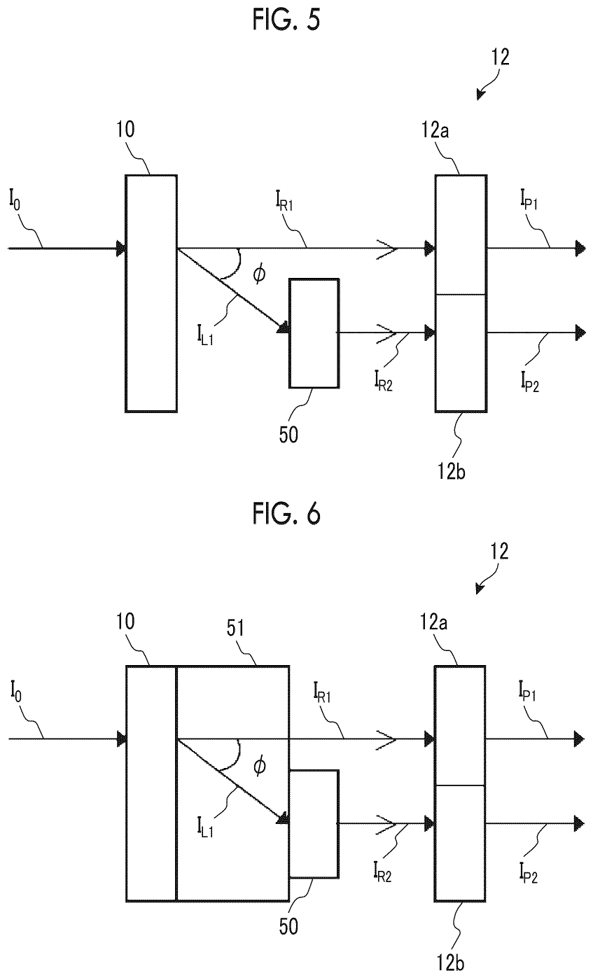

FIG. 5 is a diagram conceptually showing another example of the configuration of the beam splitter according to the embodiment of the present invention.

The beam splitter shown in FIG. 5 includes the light splitting element 10, a transmissive liquid crystal diffractive element 50 as the light collimating member, and the retardation plate 12. The example shown in FIG. 5 has the same configuration as the example shown in FIG. 1, except that it includes the transmissive liquid crystal diffractive element 50 as the light collimating member, and thus different points will be mainly described in the following description.

In FIG. 5, the transmissive liquid crystal diffractive element 50 is disposed on the optical path of the levorotatory circularly polarized light I_{L1} that transmits through the light splitting element 10 to be diffracted. The levorotatory circularly polarized light I_{L1} that transmits through the light splitting element 10 to be diffracted is incident into the transmissive liquid crystal diffractive element 50.

The transmissive liquid crystal diffractive element 50 diffracts incident circularly polarized light according to the turning direction. As in the transmissive liquid crystal diffractive element as the light splitting element 10, the transmissive liquid crystal diffractive element 50 may include an optically anisotropic film, and the optically anisotropic film is formed of a composition including a liquid crystal compound and has a predetermined liquid crystal alignment pattern in which an orientation of an optical axis derived from the liquid crystal compound continuously rotates in one in-plane direction. In addition, it is preferable that the optically anisotropic film in the transmissive liquid crystal diffractive element 50 has a so-called twisted structure in which the orientation of the molecular axis of the liquid crystal compound continuously changes from one interface side to the other interface side in a thickness direction from the viewpoint of increasing the efficiency of diffracted light and obtaining polarization preservation, and the like. The transmissive liquid crystal diffractive element 50 may include a support and/or an alignment film in addition to the optically anisotropic film.

In the example shown in FIG. 5, in the transmissive liquid crystal diffractive element 50, the levorotatory circularly polarized light I_{L1} incident from the upper left direction is diffracted to travel in the right direction. In addition, the circularly polarized light transmitted through the transmissive liquid crystal diffractive element 50 is converted in turning direction, and thus is emitted as the dextrorotatory circularly polarized light I_{R2}.

The dextrorotatory circularly polarized light I_{R2} emitted from the transmissive liquid crystal diffractive element 50 is incident into the region 12b of the retardation plate 12 to be converted into the linearly polarized light I_{P2}. In addition, the dextrorotatory circularly polarized light I_{R1} that transmits through the light splitting element 10 without being diffracted is directly incident into the region 12a of the retardation plate 12 to be converted into the linearly polarized light II.

From the above, the beam splitter shown in FIG. 5 splits incident light into two linearly polarized light components to emit the two linearly polarized light components in directions parallel to each other.

FIG. 6 is a diagram conceptually showing another example of the configuration of the beam splitter according to the embodiment of the present invention.

The beam splitter shown in FIG. 6 includes the light splitting element 10, the transmissive liquid crystal diffractive element 50 as the light collimating member, a support 51, and the retardation plate 12. The example shown in FIG. 6 has the same configuration as the example shown in FIG. 5, except that it includes the support 51, and thus different points will be mainly described in the following description.

In FIG. 6, the light splitting element 10 is disposed on a surface of the support 51 on a side into which light I₀ is incident, and the transmissive liquid crystal diffractive element 50 is disposed on the other surface side of the support 51. That is, the support 51 supports the light splitting element 10 and the transmissive liquid crystal diffractive element 50, and holds a predetermined positional relationship between the light splitting element 10 and the transmissive liquid crystal diffractive element 50. The support 51 is formed of a material such as glass or a resin having a high light-transmitting property with respect to target light.

The levorotatory circularly polarized light I_{L1} that is diffracted by the light splitting element 10 passes through the inside of the support 51 to be incident into the transmissive liquid crystal diffractive element 50, and is deflected to travel in the right direction in the drawing by the transmissive liquid crystal diffractive element 50 to be converted into the dextrorotatory circularly polarized light I_{R2}. In addition, the dextrorotatory circularly polarized light I_{R1} that transmits through the light splitting element 10 without being diffracted passes through the inside of the support 51 to be emitted in the right direction in the drawing.

The dextrorotatory circularly polarized light I_{R2} emitted from the transmissive liquid crystal diffractive element 50 is incident into the region 12b of the retardation plate 12 to be converted into the linearly polarized light I_{P2}. In addition, the dextrorotatory circularly polarized light I_{R1} that transmits through the light splitting element 10 and transmits through the support 51 is incident into the region 12a of the retardation plate 12 to be converted into the linearly polarized light I_{P1}.

From the above, the beam splitter shown in FIG. 6 splits incident light into two linearly polarized light components to emit the two linearly polarized light components in directions parallel to each other.

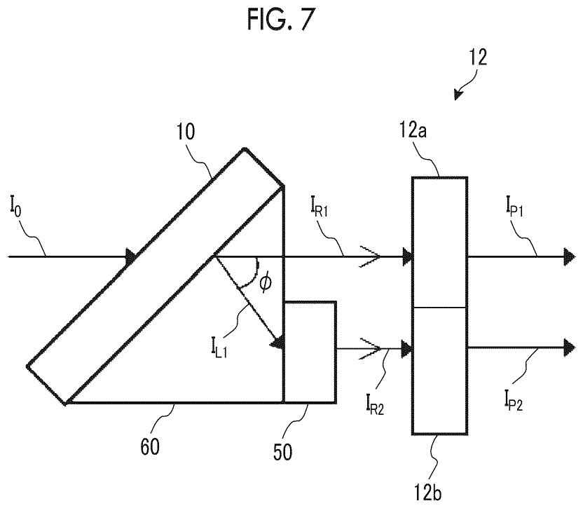

FIG. 7 is a diagram conceptually showing another example of the configuration of the beam splitter according to the embodiment of the present invention.

The beam splitter shown in FIG. 7 includes the light splitting element 10, the transmissive liquid crystal diffractive element 50 as the light collimating member, a prism 60, and the retardation plate 12. The example shown in FIG. 7 has the same configuration as the example shown in FIG. 6, except that it includes the prism 60 instead of the support 51, and thus different points will be mainly described in the following description.

In FIG. 7, the prism 60 is a so-called triangular prism, among surfaces of the prism 60 that are not parallel to each other, the light splitting element 10 is disposed on one surface (hereinafter, also referred to as an incident surface of the prism 60), and the transmissive liquid crystal diffractive element 50 is disposed on the other surface (hereinafter, also referred to as an emission surface of the prism 60). That is, the prism 60 also functions as a support that supports the light splitting element 10 and the transmissive liquid crystal diffractive element 50 and holds a predetermined positional relationship between the light splitting element 10 and the transmissive liquid crystal diffractive element 50. The prism 60 is formed of a material such as glass or a resin having a high light-transmitting property with respect to target light.

In the example shown in FIG. 7, the prism 60 is disposed such that the incidence light I₀ is incident from a direction perpendicular to the emission surface of the prism 60. Therefore, the incidence light I₀ is incident into the light splitting element 10 (the incident surface of the prism 60) from an oblique direction. In addition, in the example shown in FIG. 7, the transmissive liquid crystal diffractive element 50 is disposed in a region below the emission surface of the prism 60. That is, the emission surface of the prism 60 has a region where the transmissive liquid crystal diffractive element 50 is not disposed.

The dextrorotatory circularly polarized light component of the incidence light I₀ incident from a direction oblique to the light splitting element 10 is diffracted and emitted as the levorotatory circularly polarized light I_{L1}. In the example shown in FIG. 7, the levorotatory circularly polarized light I_{L1} is diffracted to travel in the lower right direction in the drawing, and passes through the inside of the prism 60 to be incident into the transmissive liquid crystal diffractive element 50. The levorotatory circularly polarized light I_{L1} is deflected to travel in the right direction in the drawing by the transmissive liquid crystal diffractive element 50 to be converted into the dextrorotatory circularly polarized light I_{R2}.

In addition, the dextrorotatory circularly polarized light I_{R1} transmitted through the light splitting element 10 passes through the inside of the prism 60, and is emitted in the right direction in the drawing from the region of the emission surface where the transmissive liquid crystal diffractive element 50 is not disposed. In this case, the dextrorotatory circularly polarized light I_{R1} is vertically incident into the emission surface of the prism 60, and thus travels straight and is emitted in the right direction without being bent.

The dextrorotatory circularly polarized light I_{R2} emitted from the transmissive liquid crystal diffractive element 50 is incident into the region 12b of the retardation plate 12 to be converted into the linearly polarized light I_{P2}. In addition, the dextrorotatory circularly polarized light I_{R1} that transmits through the prism 60 without being diffracted by the light splitting element 10 is incident into the region 12a of the retardation plate 12 to be converted into the linearly polarized light I_{P1}.

From the above, the beam splitter shown in FIG. 7 splits incident light into two linearly polarized light components to emit the two linearly polarized light components in directions parallel to each other.

The beam splitter according to the embodiment of the present invention can be used as an optical wavelength selective switch system.

The optical wavelength selective switch system has a function of splitting wavelength components in an optical signal transmitted through an optical fiber in wavelength multiplexing communication from each other and distributing each of the split wavelength components to a predetermined route. The optical wavelength selective switch system includes: a wavelength dispersive element that spatially splits and emits incident light for each of wavelengths; and a deflection unit that distributes the light incident from the wavelength dispersive element to a predetermined route by deflecting the light such that a reflection angle or a transmission angle of the light is variable for each of wavelengths.

As the wavelength dispersive element, for example, a prism, a surface relief diffractive element (surface relief grating: SRG), or an arrayed waveguide diffractive element (arrayed waveguide grating: AWG) is used.

As the deflection unit, a liquid crystal optical element represented by a micromirror device or a liquid crystal on silicon (LCOS) can be used.

The beam splitter according to the embodiment of the present invention can be used as an element that is disposed on an input side of the optical wavelength selective switch system, that is, upstream of the wavelength dispersive element and splits light input to the optical wavelength selective switch system such that the split light is incident into the wavelength dispersive element. The diffractive element (in particular, the surface relief diffractive element) as the wavelength dispersive element in the optical wavelength selective switch system has wavelength dependence on the diffraction efficiency. Therefore, by allowing P polarized light to be incident, the diffraction efficiency can be stabilized. A method of allowing a polarizing plate to convert incidence light into P polarized light can also be adopted, but the amount of light is reduced to about half. On the other hand, the beam splitter can suppress a decrease in the amount of light caused by converting incidence light into P polarized light.

The beam splitter according to the embodiment of the present invention can be used as an element that is disposed on an output side of the optical wavelength selective switch system, that is, downstream of the deflection unit and further splits at least one of the light components split by the optical wavelength selective switch system for each of the wavelengths.

Hereinabove, the beam splitter and the optical wavelength selective switch system according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### (Example of Embodiment of Beam Splitter)

With respect to the compound described in WO2021/256413A, a beam splitter having the same configuration as that of FIG. 6 except that a retardation layer was not provided was prepared using glass having a thickness of 1.4 [mm] as a support. Regarding a diffractive element 1 (light splitting element 10), the addition amount of a right-twisted chiral agent was adjusted such that an in-plane pitch was 2.4 [μm] and a twisted angle was 110°, an optically anisotropic film having the right-twisted structure was formed, and a transmissive liquid crystal diffractive element having a splitting angle of 40° at a wavelength of 1550 [nm] and a film thickness of 0.78 [μm] was prepared. In addition, regarding a diffractive element 2 (transmissive liquid crystal diffractive element 50), an optically anisotropic film was prepared using the same method as that of the diffractive element 1, except that the addition amount of a left-twisted chiral agent was adjusted such that a twisted angle was 1100 in the opposite direction to that of the diffractive element 1. The thickness of each of the photo-alignment films was 80 [nm], the total thickness was about 1.6 [mm], and the splitting distance was 1.2 [mm].

In addition, a splitting distance in a case where light was incident into cross-section paper disposed in a location at a distance of 10 cm from the element and a splitting distance in a case where light was incident into cross-section paper disposed in a location at a distance of 300 cm from the element are not different from each other. Therefore, it was verified that the split light components are parallel light.

The splitting angle of the transmitted light and the reflected light was obtained as follows from the splitting distance and the thickness of the support.

$$φ = arc tan ( splitting distance / thickness of support )$$

Here, the splitting distance refers to a distance between positions A and B, where A represents the position where a photodiode power sensor (manufactured by Thorlabs, Inc., S122C) was disposed such that one transmitted light was vertically incident thereinto, and B represents the position that is translated from the position A and where the other transmitted light was also vertically incident, and arctan represents an inverse trigonometric function of a tangent.

As Comparative Example, a beam displacer type splitting element consisting of YVO₄ was used. This element needed to have a thickness of 12 [mm] such that the splitting angle was 5° and the splitting distance was 1.2 [mm].

From the above results, it can be seen that the beam splitter according to Example of the present invention can be significantly thinned to about 1/7 of the thickness of the beam splitter according to Comparative Example to obtain the same splitting distance. In addition, for example, by selecting a thinner support, a further reduction in thickness can be easily realized.

### EXPLANATION OF REFERENCES

10: light splitting element (transmissive liquid crystal diffractive element)
51: support (glass)
11: light collimating member
12: retardation plate
12a, 12b: region
20: mirror
30: lens
50: transmissive liquid crystal diffractive element
40, 60: prism
I₀: incidence light
I_{R1}: split dextrorotatory circularly polarized light
I_{L1}: split levorotatory circularly polarized light
I_{R2}: collimated dextrorotatory circularly polarized light
I_{L2}: collimated levorotatory circularly polarized light
I_{P1}, I_{P2}: P polarized light (linearly polarized light)
φ: splitting angle

What is claimed is:

1. A beam splitter comprising:
a light splitting element that splits incidence light into transmitted light and transmitted diffracted light; and
a light collimating member for collimating the split light components,
wherein a splitting angle between the transmitted light and the transmitted diffracted light is 100 or more.

2. The beam splitter according to claim 1,
wherein the light splitting element is a transmissive liquid crystal diffractive element having a twisted structure of liquid crystals.

3. The beam splitter according to claim 1,
wherein the light collimating member is a transmissive liquid crystal diffractive element having a twisted structure of liquid crystals.

4. The beam splitter according to claim 1, further comprising:
a retardation plate that is provided between the light splitting element and the light collimating member or on an emission side of the light collimating member.

5. An optical wavelength selective switch system comprising:
the beam splitter according to claim 1.

6. The beam splitter according to claim 2,
wherein the light collimating member is a transmissive liquid crystal diffractive element having a twisted structure of liquid crystals.

7. The beam splitter according to claim 2, further comprising:
a retardation plate that is provided between the light splitting element and the light collimating member or on an emission side of the light collimating member.

8. An optical wavelength selective switch system comprising:
the beam splitter according to claim 2.

9. The beam splitter according to claim 3, further comprising:
a retardation plate that is provided between the light splitting element and the light collimating member or on an emission side of the light collimating member.

10. An optical wavelength selective switch system comprising:
the beam splitter according to claim 3.

11. An optical wavelength selective switch system comprising:
the beam splitter according to claim 4.
